(19) United States
(12) Patent Application Publication
(10) Pub. No.: US 2009/0232792 A1
(43) Pub. Date: Sep. 17, 2009

(54) ANTIMICROBIAL CARBON

(76) Inventors: Valerie Bicard-Benhamou, Darmstadt (DE); Herwig Buchholz, Frankfurt (DE); Marcus Brunner, Stockstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/304,861

(22) PCT Filed: May 16, 2007
(86) PCT No.: PCT/EP07/04386

§ 371 Date: Dec. 15, 2008

(30) Foreign Application Priority Data
Jun. 16, 2006 (EP) 06012439.3

(51) Int. Cl. A01N 59/00; A01P 1/00

(52) U.S. Cl. 424/125

(57) ABSTRACT

The present invention relates to antimicrobial carbon and to its use, especially for treating diseases and toxications of the gastrointestinal tracts, in particular diarrhoea.

The present invention relates to antimicrobial carbon and to its use, especially for treating diseases and toxications of the gastrointestinal tracts, in particular diarrhoea.

By the term diarrhoea, there is understood the occurrence of too frequent thinly liquid emptying of the intestine. These illnesses are brought about by hypermotility of the intestine, by disturbances of the secretion as well as disturbances of the resorption in the small and large intestine. The main cause of these disturbances frequently is a change in the contents of the intestine, particularly changes of the normal intestinal flora through colonies of pathogenic germs (bacteria) alien to the intestine or through the absorption of toxic substances.

Severe, persistent diarrhoeas signify large losses of water and electrolyte which particularly in infants can lead to life threatening circulatory collapse and then can be interpreted through intravenous salt and sugar infusions, in extreme cases only by plasma transfusions. Therefore, it is absolutely necessary to stop these large water and electrolyte losses as soon as possible.

For a long time it has been customary to treat diarrhoeas with adsorbents, which include for example carbon (including activated carbon) and Bolus alba (kaolin). Adsorbents bind bacteria, bacterial toxin and local irritating materials by physical reversible fixing on their active surfaces. The medicinal carbon is a so-called activated carbon in which through a specific process there is produced the largest possible effective surface area. It has been reported that, when internally administered, the medicinal carbon shows excellent therapeutical efficacy particularly on bacterial-infectious diseases such as dysentery, cholera, typhoid abdominalis, alimentary intoxication, indigestion, flatus in intestines, chronic gastritis, epilepsy, dizziness, chlorosis, anthrax and the like. In cases of undesirable intake of drug and poison, the first-aid oral administration of medicinal carbon produces an antidotal virtue. Furthermore, the internal use of medicinal carbon is effective for removing from gastrointestinal tracts noxious substances which formed due to an abnormality in metabolism caused by various diseases. These effects are considered to be due to the fact that toxins, abnormal metabolites or substances which induce the formation of such toxins and/or abnormal metabolites in the gastrointestinal tracts are adsorbed on the medicinal carbon which is completely harmless to living bodies and the medicinal carbon orally administered to living body is discharged outside of the body bearing thereon the above-mentioned noxious substances.

The above-mentioned medicinal carbon is only able to adsorb the noxious substances or to bind the bacteria. In many cases it is desirable not only to remove bacteria, but also to kill them, since the further production of toxic substances by the bacteria is reduced quickly. Therefore, there is a great demand for alternatives for the common medicinal carbon that is not only able to adsorb bacteria, but also is able to kill them, preferably in best time.

It is therefore the objective of the present invention to provide materials that not only bind bacteria but also reduce their number by killing them.

This objective is accomplished by antimicrobial carbon according to the present invention. Preferably the antimicrobial carbon is an antimicrobial medicinal carbon.

Therefore the present invention is directed to antimicrobial carbon, preferably medicinal carbon, obtainable by agitating a suspension and/or solution comprising carbon, preferably activated carbon, and silver oxide as antimicrobial compound.

It was found that the chemical reaction between preferably used medicinal carbon typically used to treat acute diarrhoea with silver salts gave rise to a material showing a strong antimicrobial activity. The high adsorption capacity of the carbon is not affected by the silver bound to it. The obtained material is therefore very well suited to adsorb and bind bacteria and is concurrently releasing silver ions that reduce the number of bacteria thus enabling to treat diarrhoea in a more effective manner.

The advantage of such an antimicrobial carbon in comparison to a physical mixture of carbon with silver salts is notably, especially in the case of medicinal carbon, to avoid any galenic incompatibilities. In addition, solubility issues of silver salts are overcome by the treatment method of medicinal carbon with silver compounds like silver oxide or other silver salts. High surface distribution of the silver species ensures superior activity at the surface, thus needing only small amounts of silver species.

The antimicrobial carbon according to the present invention can in general be based on any kind of carbon, preferably activated carbon, especially activated carbon used as medicinal carbon. The starting material for the above-mentioned medicinal carbon are any of known ones including sawdust, coal, coconut shell, pitch, organic synthetic polymer and the like. Preferably, the medicinal carbon is based on coconut shell. In particular the medicinal carbon is the one as used in the commercially available Kohle-Compretten® from Merck KGaA, Darmstadt, Germany.

The preferred medicinal carbon used in the present invention can also be in the form of spherical particles. Such spherical particles are obtainable by a process which comprises the steps of shaping an above-mentioned powdery material into small-sized spheres by the use of a binder such as pitch, heating and baking for carbonization of the thus formed spheres in an inert atmosphere at a temperature of 800-1000° C., and activating them in an atmosphere of steam at a temperature of 900-1000° C. This type of process is known to the person skilled in the art. Usually the resulting spheres have a diameter of 0.05-2 mm, preferably 0.1-1.0 mm, the surface area is in the range of 500-2000 m²/g, preferably 700-1500 m²/g, as determined by a commercially available surface area-determining instrument. The volume of the pore cavities is determined by a commercially available mercury porosimeter and is generally in the range of 0.05-1.0 cm³/g, preferably 0.1-0.8 cm³/g with a pore-radius of 100-75000 Å.

Antimicrobial carbon according to the present invention can be obtained in a simple way. Accordingly, methods for the preparation of antimicrobial carbon, preferably antimicrobial medicinal carbon, are also part of the present invention. A preferred process for the production of the antimicrobial medicinal carbon according to the present invention includes the agitation of a suspension and/or solution comprising carbon, preferably activated carbon, and silver oxide as antimicrobial component. The process is based on a process described by A. Goetz, E. C. Y. Inn in “Reversible Photolysis of Ag Sorbed on Collodial Metal Oxides” in Rev. Modern Phys. 1948, 20, 131-142. In this context it is surprising that a process which is directed to the binding of silver cations to an oxidic surface can also be used to bind silver cations to the surface of carbon.

The preparation can be performed in water, ethanol, methanol, 1-propanol, 2-propanol and/or mixtures thereof, preferably water is used. The preparation temperature can vary between 10 and 60° C., preferably between 20 and 45° C. and is most preferably held at 37° C.

The suspension and/or solution is agitated from 4 up to 24 hours, preferably from 8 to 20 hours, and most preferably from 10 to 18 hours.

Similar carbon with antimicrobial activity can be obtained by substituting silver oxide by other antimicrobial compounds, such as for example silver salts, for example silver halogenide, silver nitrate, silver sulfate, silver carboxylates such as silver acetate, silver benzoate, silver carbonate, silver citrate, silver lactate, silver salicylate, but also copper oxides, copper sulfide, copper nitrate, copper carbonate, copper sulfate, copper halogenides, copper carboxylates, zinc oxide, zinc sulfide, zinc silicate, zinc acetate, zinc chloride, zinc nitrate, zinc sulfate, zinc gluconate, zinc citrate, zinc phosphate, zinc propionate, zinc salicylate, zinc lactate, zinc oxalate, zinc iodate, zinc iodide or combinations thereof. Silver oxide, silver acetate copper sulfate, zinc acetate are the most preferably used.

The amount of the antimicrobial compound is in the range of 0.001 to 10% by weight, preferably 0.005 to 5% by weight and most preferably 0.01 to 0.5% by weight, based on the carbon, especially the medicinal carbon.

The resulting antimicrobial carbon can be separated using any method known for a person skilled in the art. Preferably the product is filtrated or filtrated with suction and washed with water. Additionally the silver treated carbon can be further washed with organic solvents, such as acetone, to remove residual water. The antimicrobial carbon according to the present invention can be dried. Preferably the antimicrobial carbon is dried in an oven, most preferably at a temperature below 50° C., or by using a vacuum pump or a continuous flash evaporator, most preferably by evaporation of the solvents in vacuum.

The production process described can be performed easily and adds an antimicrobial activity to the features of the introduced carbon, namely a great adsorption capability. All compounds needed are readily available and can be easily handled. The process can be performed directly following the production process of the carbon, especially the medicinal carbon, without technical expense.

This invention also provides a pharmaceutical or cosmetic composition which comprises at least one antimicrobial carbon, preferably antimicrobial medicinal carbon according to the present invention and a pharmaceutically acceptable carrier. Preferably the pharmaceutical composition is used for oral application. In case of cosmetic compositions these are preferably used for topical applications.

A suitable method for the preparation of pharmaceutical or cosmetic compositions comprises the mixing of antimicrobial carbon according to the present invention with a pharmaceutically or cosmetically acceptable carrier.

Depending on the type of the pharmaceutical or cosmetic compositions, the amount of the introduced antimicrobial carbon may be varied in the range between 0.1 to 99% by weight. If a dark colour of the product is desired, for example in the case of eye-shadows, the amount of antimicrobial carbon can be raised up to 99% by weight. Smaller amounts, for example up to 10% by weight, are used in the case, that the antimicrobial carbon is used as a preservative. In this case, the antimicrobial properties can be used to reduce the necessary amount of preservatives that are additionally introduced into the composition. The use of antimicrobial carbon according to the present invention as preservative is therefore a further topic of the present invention.

Pharmaceutical compositions of antimicrobial medicinal carbon prepared as hereinbefore described may be formulated as suspensions of the powders for oral administration. Powders may be reconstituted by addition of a suitable diluent or other pharmaceutically acceptable carrier prior to use. The liquid formulation may be a buffered, isotonic, aqueous solution. Examples of suitable diluents are normal isotonic saline solution, standard 5% dextrose in water or buffered sodium or ammonium acetate solution. Such formulation may be used for oral administration. It may be desirable to add excipients such as poly vinylpyrrolidone, gelatine, hydroxy cellulose, acacia, polyethylene glycol, mannitol, sodium chloride or sodium citrate. Alternately, these compounds may be encapsulated, tableted or prepared in an emulsion or syrup for oral administration. Pharmaceutically acceptable solid or liquid carriers may be added to enhance or stabilize the composition, or to facilitate preparation of the composition. For oral administration, the pharmaceutical compositions may take the form of solid dose forms, for example, tablets (swallowable-only), capsules or gelcaps, prepared by conventional means with pharmaceutically acceptable excipients such as calcium sulfate dihydrate, terra alba or stearic acid, talc, pectin, acacia, agar or gelatine or binding agents (e.g. pregelatinised maize starch, polyvinylpyrrolidone or hydroxypropyl methylcellulose); fillers, e.g. lactose, microcrystalline cellulose or calcium phosphate lubricants, e.g. magnesium stearate, talc or silica, disintegrants, e.g. potato starch or sodium starch glycollate or wetting agents, e.g. sodium lauryl sulphate. The tablets may be coated by methods well known in the art.

Liquid carriers include syrup, peanut oil, olive oil, saline and water. The carrier may also include a sustained release material such as glyceryl monostearate or glyceryl distearate, alone or with a wax. The pharmaceutical preparations are made following the conventional techniques of pharmacy involving milling, mixing, granulating, and compressing, when necessary, for tablet forms; or milling, mixing and filling for hard gelatine capsule forms. When a liquid carrier is used, the preparation will be in the form of syrup, elixir, emulsion or an aqueous or non-aqueous suspension. Such a liquid formulation may be administered directly peroral or filled into a soft gelatine capsule.

Cosmetic compositions of antimicrobial carbon prepared as hereinbefore described may be formulated for example as lipsticks, lip-care sticks, mascara, eyeliner, eye-shadow, rouge, powder make-up, emulsion make-up and wax make-up, preferably as mascara, eyeliner or eye-shadow. The cosmetic composition further contains ingredients, which are usually used for the corresponding application. For example, besides the antimicrobial carbon, ingredients in mascara include water, wax thickeners, film-formers and preservatives. Further ingredients may be introduced and are known to the person skilled in the art.

In cosmetic applications the use of antimicrobial carbon according to the present invention has the advantage that the colouring property of the carbon is combined with an antimicrobial property. The bifunctional property of the antimicrobial carbon can be used to reduce the amount of preservative which is necessary to prevent the composition to be degraded by microorganisms.

Furthermore, the present invention is directed to the use of antimicrobial carbon according to the present invention as a medicament, preferably for the treatment of diarrhoea, or as an antidote. In this case, antimicrobial medicinal carbon is preferred. The medicament may be in the form of any known formulation as described above.

Accordingly, the antimicrobial carbon according to the present invention can be used in the manufacture of a medicament, especially for the treatment of diarrhoea.

The antimicrobial carbon and its production process according to the present invention is more illustratively demonstrated but not limited by means of the following examples.

### EXAMPLES

### 1) Preparation of Antimicrobial Carbon

14 g medicinal carbon (Kohle-Compretten®, Merck KGaA, Darmstadt, Germany) are suspended in 60 ml demineralised water. 0.09% by weight silver acetate, based on the amount of medicinal carbon, is added to the suspension. The suspension is stirred for 14 hours at 37° C. The resulting suspension is then filtered and washed 3 times with demineralised water, then 5 times with acetone. The product is dried under vacuum in a dryer cabinet.

### 2) Antimicrobial Investigation

A standard procedure from the European Pharmacopeia is used to measure the antimicrobial activity of the antimicrobial carbon. A suspension of test organisms (10⁵ to 10⁶ CFU/ml) is inoculated into a recipient containing the antimicrobial carbon to be tested. Samples of the inoculated suspension are taken and the number of germs is measured with the commonly known Agar plates method. Germ counts are done at t=0, t=24 h, t=48 h, t=7 days, t=14 days and t=28 days after inoculation.

The results are expressed in log of the reduction (log Inoculum−log(germ count)ₜ). The higher the value, the better the antimicrobial activity.

### Comparison: Untreated Kohle-Compretten®

| | Microbial reduction expressed in log: | | | | |
|---|---|---|---|---|---|
| | (log Inoculum − log (Germ count)ₜ | | | | |
| | Escherichia | Pseudomonas | Staphylococcus | Candida | Aspergillus |
| | coli | aeruginosa | aureus | albicans | niger |
| t | (ATCC 8739) | (ATCC 9027) | (ATCC 6538) | (ATCC 10231) | (ATCC 16404) |
| 0 | 0 | 0 | 0 | 0 | 0 |
| 24 h | 0 | 0 | 0 | 0 | 0 |
| 48 h | 0 | 0 | 0 | 0 | 0 |
| 7 d | 0 | 0 | 1 | 0 | 0 |
| 14 d | 0 | 0 | 1 | 0 | 0 |
| 28 d | 0 | 0 | ≧3 | 0 | 0 |

Inoculum (E. coli) = 2.6 · 10⁵ CFU/ml
Inoculum (P. aeruginosa) = 2.3 · 10⁵ CFU/ml
Inoculum (S. aureus) = 2.6 · 10⁵ CFU/ml
Inoculum (C. albicans) = 2.6 · 10⁵ CFU/ml
Inoculum (A. niger) = 2.4 · 10⁵ CFU/ml

Example: Kohle Compretten® according to Example 1) with 0.09% by weight content of Ag

| | Microbial reduction expressed in log: | | | | |
|---|---|---|---|---|---|
| | (log Inoculum − log (Germ count)t | | | | |
| | Escherichia | Pseudomonas | Staphylococcus | Candida | Aspergillus |
| | coli | aeruginosa | aureus | albicans | niger |
| t | (ATCC 8739) | (ATCC 9027) | (ATCC 6538) | (ATCC 10231) | (ATCC 16404) |
| 0 | 0 | 1 | 0 | 0 | 0 |
| 24 h | 5 | 5 | 5 | ≧3 | 1 |
| 48 h | 5 | 5 | 5 | ≧3 | 1 |
| 7 d | 5 | 5 | 5 | ≧3 | 1 |
| 14 d | 5 | 5 | 5 | 5 | 1 |
| 28 d | 5 | 5 | 5 | 5 | 2 |

Inoculum (E. coli) = 2.6 · 10⁵ CFU/ml
Inoculum (P. aeruginosa) = 2.3 · 10⁵ CFU/ml
Inoculum (S. aureus) = 2.6 · 10⁵ CFU/ml
Inoculum (C. albicans) = 2.6 · 10⁵ CFU/ml
Inoculum (A. niger) = 2.4 · 10⁵ CFU/ml

Similar results are obtained by using antimicrobial carbon with a silver content of 2.3% by weight.

1. Antimicrobial carbon, obtainable by agitating a suspension and/or solution comprising carbon, preferably activated carbon and silver oxide as antimicrobial compound.

2. Antimicrobial carbon according to claim 1, characterized in that the used activated carbon in the suspension and/or solution is medicinal carbon.

3. Antimicrobial carbon according to claims 1 or 2, characterized in that the used activated carbon in the suspension and/or solution is based on coconut shell.

4. Antimicrobial carbon according to claim 1, characterized in that the used silver oxide in the suspension and/or solution is substituted by silver halogenide, silver nitrate, silver sulfate, silver carboxylates, silver carbonate, silver citrate, copper oxides, copper sulfide, copper nitrate, copper carbonate, copper sulfate, copper halogenides, copper carboxylates, zinc oxide, zinc sulfide, zinc silicate, zinc acetate, zinc chloride, zinc nitrate, zinc sulfate, zinc gluconate, zinc citrate, zinc phosphate, zinc propionate, zinc salicylate, zinc lactate, zinc oxalate, zinc iodate, zinc iodide or combinations thereof.

5. Antimicrobial carbon according to claim 1, characterized in that the used amount of the antimicrobial compound in the suspension and/or solution is in the range of 0.001 to 10% by weight, preferably between 0.005 and 5% by weight, based on the activated carbon.

6. Method for the preparation of antimicrobial carbon according to claim 1, comprising the agitation of a suspension and/or solution comprising carbon, preferably activated carbon and silver oxide as antimicrobial compound.

7. Method according to claim 6, characterized in that the preparation is performed in water, ethanol, methanol, 1-propanol, 2-propanol and/or mixtures thereof.

8. Method according to claim 6, characterized in that the preparation temperature is between 10 and 60° C.

9. Method according to claim 1, characterized in that the suspension and/or solution is agitated from 4 up to 24 hours.

10. Method according to claim 1, characterized in that the silver oxide is substituted by silver halogenide, silver nitrate, silver sulfate, silver carboxylates, silver carbonate, silver citrate, copper oxides, copper sulfide, copper nitrate, copper carbonate, copper sulfate, copper halogenides, copper carboxylates, zinc oxide, zinc sulfide, zinc silicate, zinc acetate, zinc chloride, zinc nitrate, zinc sulfate, zinc gluconate, zinc citrate, zinc phosphate, zinc propionate, zinc salicylate, zinc lactate, zinc oxalate, zinc iodate, zinc iodide or combinations thereof.

11. A method of using an antimicrobial carbon according to claim 1 comprising employing said antimicrobial carbon as a preservative.

12. A method of using an antimicrobial carbon according to claim 1 comprising employing said antimicrobial carbon as a medicament.

13. A method according to claim 12, characterized in that the medicament is used for the treatment of diarrhoea or as antidote.

14. A method of using an antimicrobial carbon according to claim 1 comprising manufacturing a medicament for the treatment of diarrhoea with said antimicrobial carbon.

15. A pharmaceutical or cosmetic composition comprising antimicrobial carbon according to claim 1 together with a pharmaceutically or cosmetically acceptable carrier.

16. A pharmaceutical composition according to claim 15, characterized in that the pharmaceutical composition is used for oral application.

17. A cosmetic composition according to claim 15, characterized in that the cosmetic composition is used for topical application.

18. A pharmaceutical or cosmetic composition according to claim 15, characterised in that the amount of antimicrobial carbon is in the range between 0.1 to 99% by weight.

19. Method for the preparation of a pharmaceutical or cosmetic composition according to claim 15, comprising the mixing of antimicrobial carbon with a pharmaceutically or cosmetically acceptable carrier.
